(19) United States
(12) Patent Application Publication
(10) Pub. No.: US 2019/0354961 A1
(43) Pub. Date: Nov. 21, 2019

(54) INTERNET OF THINGS MERCHAN ORDER AND PAYMENT ENABLEMENT

(71) Applicant: VISA INTERNATIONAL SERVICE ASSOCIATION, SAN FRANCISCO, CA (US)

(72) Inventors: Dan Macias, San Francisco, CA (US); Vishwanath Shastry, San Francisco, CA (US); Kyle Joseph Drechsler, San Francisco, CA (US)

(21) Appl. No.: 16/483,656

(22) PCT Filed: Feb. 6, 2018
(86) PCT No.: PCT/US18/16975

§ 371 Date: Aug. 5, 2019

Related U.S. Application Data
(60) Provisional application No. 62/455,525, filed on Feb. 6, 2017.

(51) Int. Cl. G06Q 20/36; G06Q 20/32

(52) U.S. Cl. CPC G06Q 20/367; G06Q 20/32; G06Q 20/363

(57) ABSTRACT

The present system and method may solve several of the hurdles using existing and enhanced virtual wallet capabilities.

### BACKGROUND

Some challenges in the Internet of Things (IoT) space are:

1. How does a device or appliance know what consumer products are available for purchase and from where?

2. How does the user authenticate for payment on the device?

3. How do the order details reach the merchant to be fulfilled, including payment information

### SUMMARY

The present system and method may solve several of the hurdles using existing and enhanced virtual wallet capabilities:

1. A virtual wallet Call ID may be used to securely send payment information to merchants, allowing merchants to request encrypted payment data via API directly from the merchant wallet provider;

2. The virtual wallet encrypted payload may be used to pass order level details, such as sku, quantity, order confirmation method, etc using custom v.init data elements. Merchants may receive this information when decrypting the same payload that contains payment data;

3. Consumers may authenticate and create a virtual wallet Call ID by either directly interacting with the virtual wallet application on a web view (e.g. screen on a refrigerator), or indirectly using a digital wallet through the virtual wallet open platform;

4. The IoT provider may be configured as a virtual wallet partner of the merchants, which may allow the partner to create a virtual wallet Call ID that allows only a specific merchant to decrypt;

5. The virtual wallet may provide a Call ID Exchange API, which may provide the capability for partners (only certified partners) to generate a new Call ID specific to a merchant and refresh the variable v.init data elements (e.g amount, currency, custom variables, etc). Consumer payment information may always remain the same which may allow the partner to generate new Call IDs to send to multiple merchants, without requiring the user to re-authenticate into the virtual wallet each time if they are using the original payment instrument authenticated for that particular IoT device

### BRIEF DESCRIPTION OF THE DRAWINGS

FIG. 1 may illustrate a sample method that may be performed by the processor;

FIG. 2 may illustrate a relationship between an IoT partner and merchant profiles;

FIG. 3 may illustrate an IoT device payment installation and order flow;

FIG. 4 may be an illustration of a portable computer system and a server computer system;

FIG. 5 may be an illustration of a portable computing system; and

FIG. 6 may be an illustration of a sample server computing system with a database.

### SPECIFICATION

The present disclosure now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the example embodiments may take the form of an entirely hardware embodiment, an entirely software embodiment, or an embodiment combining software and hardware aspects. The following detailed description is, therefore, not to be taken in a limiting sense. The servers may be in a single server, a server with multiple processors or in processors that are remote but are in communication with each other. The processors may be physically configured as hardware or may be physically configured according to computer executable instructions which physically configure the processor to perform computer operations as described herein.

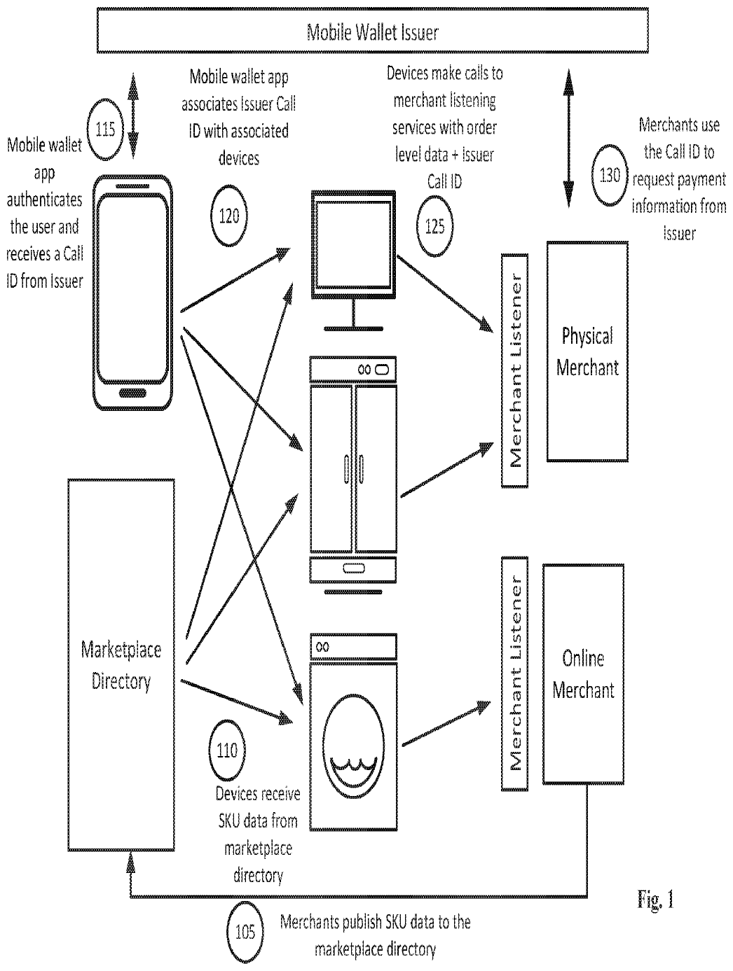

FIG. 1 may illustrate a sample method that may be performed by the processor. At block 105, merchants may push product data to a central directory/marketplace with SKU catalog information (price, shipping, inventory, image, description, etc).

A virtual wallet issuer such as Visa may provide this directory and application programming interface (API) to merchants as part of the mobile wallet checkout integration such as Visa Checkout Merchant Integration. A virtual wallet may allow a plurality of payment devices to be access and used for purchases by entering a name and password into a mobile application.

At block 110, an internet of things (IoT) device may require a way to subscribe to, and receive, product data. An internet of things device may be a traditional device that has internet access added to it. For example, a bathroom scale may already exist but by adding wireless access to the scale, additional functionality may be added to the scale and the scale may interact with applications and other wireless devices. Other examples include computer monitors, washing machines, refrigerators, etc. Virtual wallet application providers such as Visa may offer subscription services and APIs to IoT partners as part of the virtual wallet application such as the Visa Checkout Partner Integration.

At block 115, a consumer may use a virtual wallet such as Visa Checkout, or a Visa Checkout Open Platform enabled digital wallet, to authenticate with a particular device and establish payment activation. A virtual wallet all ID such as a Visa Checkout Call ID may be returned and associated to that user in the IoT Partner system.

At block 120, a IoT partner such as device manufacture (such as the bathroom scale manufacturer) may associate the virtual wallet app call ID such as Visa Checkout Call ID and User to the IoT device which is activated for payments.

At block 125, in response to an order that may be placed on an IoT device, order and payment data may be transmitted to the merchant for authorization and order confirmation.

It is at this point that a Call ID Exchange API may be used by the IoT partner to generate a new virtual wallet checkout call ID such as a Visa Checkout Call ID for this specific order. The partner may provide:

original Call ID,

merchant external ClientId, and

additional v.init parameters specific to the order (amount, currency, SKU, quantity, shipping method, etc).

The virtual wallet provider such as Visa may return a new Call ID that is associated to a payment, for which only that particular merchant may request.

The merchant may then need to provide a service for which IoT devices and/or services can push order requests. As an example, the bathroom scale may require a call for a specific type of food depending on if the scale reads higher or lower than desired.

At block 130, a merchant may use the Call ID received to request payment data using the virtual wallet API such as the Visa Checkout getPaymentData API. The data returned may be encrypted using the merchant API credentials.

The data received by the merchant may be applicable to the merchant's virtual wallet profile such as the merchant's Visa Checkout profile. For example, if the merchant was enabled for Tokens vs PAN, then the proper account number would be communicated (Token or PAN).

At block 135, the merchant may confirm the order back to the consumer either by direct API response, or by the virtual wallet provider such as Visa push notification if the original authentication was done performing the virtual wallet provider platform such as Visa Checkout Open Platform.

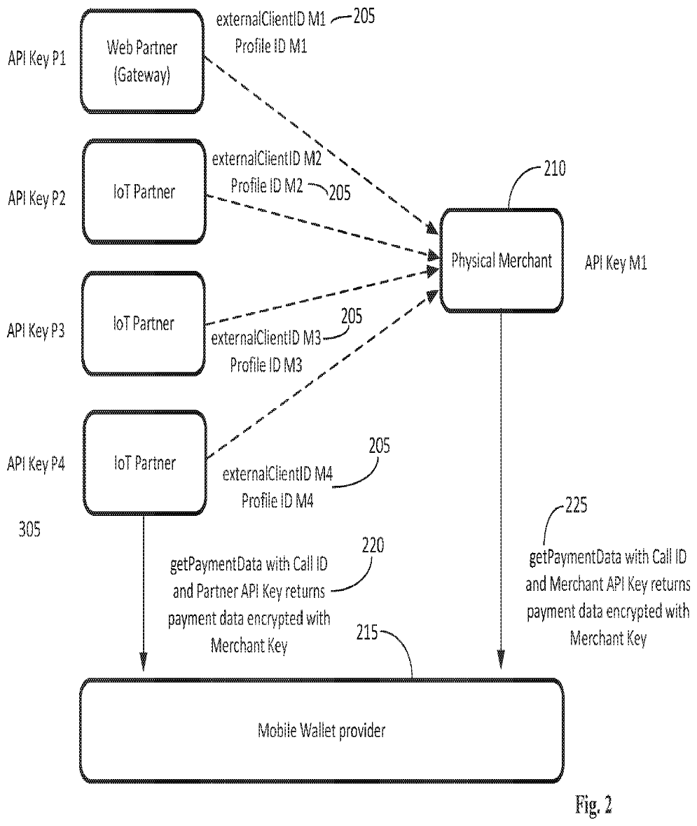

FIG. 2 may illustrate a relationship between an IoT partner and merchant profiles. The relationship between the IoT partner 205 and the merchant 310 illustrates the ability for the IoT partner 205 to use their own API credential to generate a virtual wallet intent message associated to the merchant 210, for which the merchant 210 may successfully request and decrypt payment data. The arrangement may support the passing of payment information from the partner 205 to the merchant 210 by only sending a secure transaction ID. The reverse flow also is possible and more common for gateways and acquirers. As illustrated, in some situation the Partner API key 220 may return payment data encrypted with a Merchant Key and in other situations, the Merchant API Key may return payment data encrypted with the Merchant Key 225.

The external Client ID 205 may define the unique relationship ID shared between the partner 205 and merchant 210. Merchants 210 may have the ability to “subscribe” to partners 205 via an online user interface with the virtual wallet provider such as selecting the relationship tab in the Visa Digital Business Center.

IoT partners 205 may have the ability to onboard new merchants 210 via an API. However, current functionality may not provide a “lookup and connect” feature, only a brand new account creation for security purposes. Connecting an existing merchant 205 to a partner 210 may require manual relationship creation by the merchant 205 or by the virtual wallet provider 215 like Visa on the merchant's behalf.

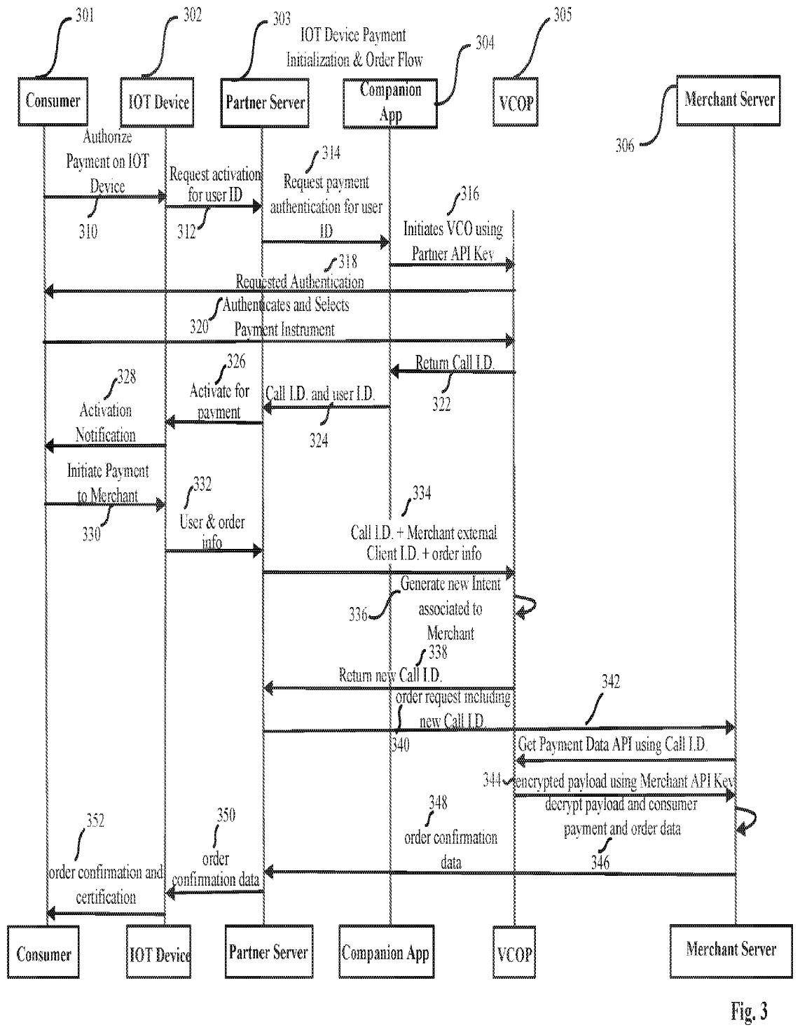

FIG. 3 may illustrate an IoT device payment installation and order flow. The various parties to the flow may include a consumer 301, an IoT device 302, a Partner server 303 and Companion App 304, a Virtual wallet provider platform 305 and a Merchant server 306.

At block 310, an authorize payment on an IoT device may be communicated from a consumer 301 to an IoT device 302. For example, a consumer 301 may make a selection on a refrigerator that has internet access and a touch screen which may be the IoT device 302. The request for activation may be communicated from the IoT device 302 to a partner server 303 at block 312. At block 314, the request payment authentication for the User Id may be communicated from the partner server 303 to the companion app 304. At block 316, the companion app 304 may initiate a virtual wallet such as Visa Checkout using the partner 303 API key which may be communicated to a virtual wallet partner such as a Visa Checkout Partner.

At block 318, the virtual wallet platform 305 may request authentication from the consumer 301. At block 320, the consumer 301 may receive a message on the virtual wallet to select a payment instrument from the virtual wallet application and to authenticate the payment. The authentication may be communicated from the consumer 301 to the virtual wallet platform 305.

At block 322, the virtual wallet platform 305, such as a Visa Checkout Open Platform, may return a Call ID to the companion application such as a virtual wallet 304.

At block 324, the companion app such as the virtual wallet 304 may communicate the Call Id and User Id to the partner server 303.

At block 326, the partner server 303 may communicate an activate for payment signal to the IoT device 302. In response, at block 328, the IoT device may communicate an activation notification 328 to the consumer 301.

In response to the consumer responding affirmatively to the activate for payment signal from block 328, the system may initiate payment to the merchant at block 330 by communicating an initiate payment signal to the IoT device. At block 332, the IoT device may communicate user and order information top the partner server 303.

In response, at block 334, the partner server may communicate the Call Id and Merchant External Client ID and order information to the Virtual wallet open platform 305. At block 336, the virtual wallet open platform may generate a new intent message associated to the merchant.

At block 338, the virtual wallet open platform 305 may return a Call Id message to the partner server 303. The partner server 303 at block 340 may communicate an order request including a new Call ID to the Merchant Server 306.

At block 342, the Merchant server 306 may communicate GetPaymentData API using Call ID to the virtual wallet open platform 305. At block 344, the virtual wallet open platform 305 may communicate an encrypted payload using the Merchant API key to the Merchant 306. The Merchant 306 may decrypt the payload and consumer payment and order data at block 346 in order to fill the order.

At block 348, the Merchant 306 may communicate order confirmation data 348 to the partner server 303. The partner server 303 may then communicate the order confirmation data tot eh IoT device at block 350. At block 352, the IoT device 302 may communicate the order confirmation notification to the consumer 301.

As a result of the system and method, several of the hurdles of using IoT devices in a transaction may be addressed by existing and enhanced virtual wallet open platforms such as the Visa Checkout Open Platform capabilities. A virtual wallet Call ID such as Visa Checkout Call ID may be used to securely send payment information to merchants, allowing merchants to request encrypted payment data via API directly from the virtual wallet provider such as Visa.

In addition, virtual wallet encrypted payload may be used to pass order level details, such as sku, quantity, order confirmation method, etc., using custom v.init data elements. Merchants may receive this information when decrypting the same payload that contains payment data.

Consumers may authenticate and create a virtual wallet Call ID such as a Visa Checkout Call ID by either directly interacting with the virtual wallet such as Visa Checkout on a web view (e.g. screen on a refrigerator), or indirectly using a digital wallet through the virtual wallet open platform such as Visa Checkout Open Platform.

The IoT provider may be configured as a virtual wallet partner of the merchants such as a Visa Checkout partner of the merchants, which may allow the partner to create a Call ID such as a Visa Checkout Call ID that allows only a specific merchant to decrypt.

The virtual wallet may provide a Call ID Exchange API, which may provide the capability for partners (only certified partners) to generate a new Call ID specific to a merchant and refresh the variable v.init data elements (e.g amount, currency, custom variables, etc). Consumer payment information may remain the same which may allow the partner to generate new Call IDs to send to multiple merchants, without requiring the user to re-authenticate into the virtual wallet such as Visa Checkout each time if they are using the original payment instrument authenticated for that particular IoT device.

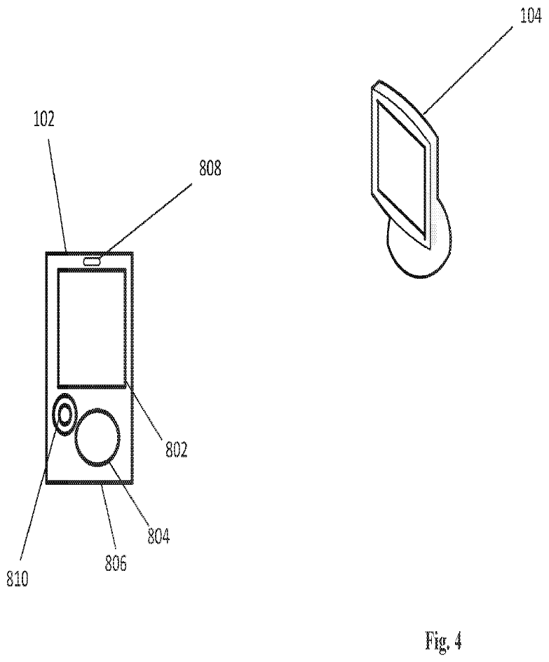

FIG. 4 may be a high level illustration of some of the elements a sample computing environment that may be physically configured to implement the various embodiments of the method and its logical variants. A user device 102 in the computing environment may store a software payment application that may be accessed in a variety of ways. There may be various versions of the application to take advantage of the benefits of different computing devices, different languages and different API platforms. In some embodiments, the entire system 103 may be accessed through a portable computing device 102 such as a smart phone and the desired activities directed toward clients may occur using a portable computing device 102.

The user device 102 may have a display 802 which may or may not be a touch sensitive display. More specifically, the display 802 may have a capacitance sensor, for example, that may be used to provide input data to the user device 102. In other embodiments, an input pad 804 such as arrows, scroll wheels, keyboards, etc., may be used to provide inputs to the user device 102. In addition, the user device 102 may have a microphone 806 which may accept and store verbal data, a camera 808 to accept images and a speaker 810 to communicate sounds.

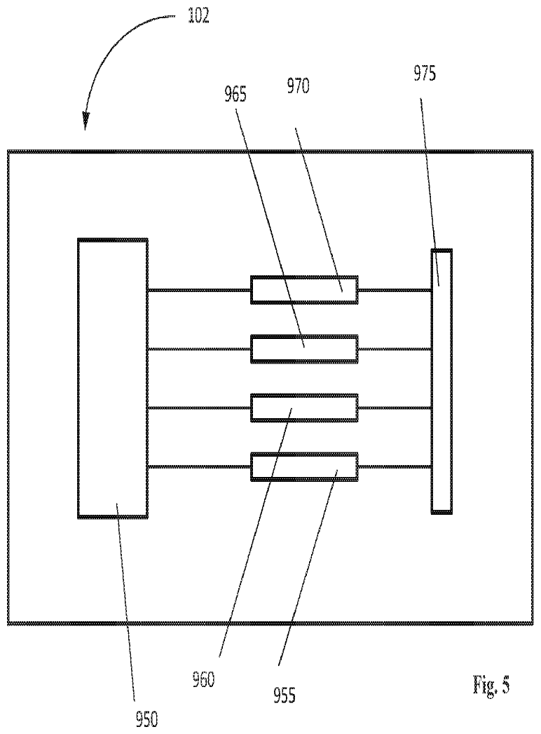

The user device 102 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server 104 or through a wireless network, e.g., Bluetooth, etc. FIG. 5 may be a simplified illustration of the physical elements that make up a user device 102 and FIG. 5 may be a simplified illustration of the physical elements that make up the server 104.

FIG. 5 may be a sample user device 102 that is physically configured according to be part of the system. The user device 102 may have a processor 950 that is physically configured according to computer executable instructions. It may have a portable power supply 955 such as a battery which may be rechargeable. It may also have a sound and video module 960 which assists in displaying video and sound and may turn off when not in use to conserve power and battery life. The user device 102 may also have volatile memory 965 and non-volatile memory 970. There also may be an input/output bus 975 that shuttles data to and from the various user input devices such as the microphone 906, the camera 908 and other inputs 902, etc. It also may control of communicating with the networks, either through wireless or wired devices. Of course, this is just one embodiment of the portable computing device 102 and the number and types of portable computing devices 102 is limited only by the imagination.

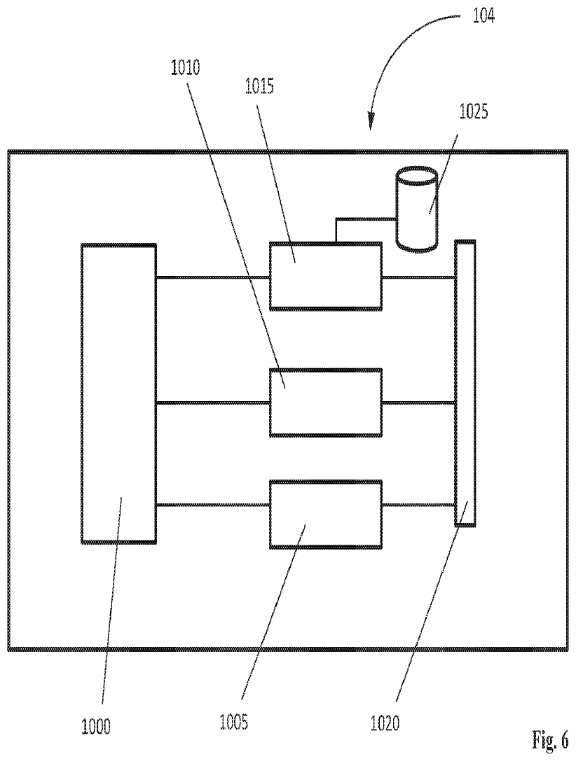

An example of the physical elements that make up a server 104 such as the transaction server 113, learning server 123, reviewing server 133 and analysis server 143 may be further illustrated in FIG. 6. Some of the physical elements may be located in other devices, depending on processing needs. The server 104 may have a processor 1000 that is physically configured according to computer executable instructions. It may also have a sound and video module 1005 which assists in displaying video and sound and may turn off when not in use to conserve power and battery life. The server 104 may also have volatile memory 1010 and non-volatile memory 1015. And as mentioned previously, each server may be physically built to meet the specific identified task.

In some examples, the server 104 may include a digital storage such as a magnetic disk, an optical disk, flash storage, non-volatile storage, etc. Structured data may be stored in the digital storage such as in a database. A database 1025 may be stored in the memory 1010 or 1015 or may be separate. The database 1025 may also be part of a cloud and may be stored in a distributed manner. There also may be an input/output bus 1020 that shuttles data to and from the various user input devices such as the microphone 806, the camera 808, the inputs 802, etc. The input/output bus 1020 also may control of communicating with the networks, either through wireless or wired devices. Of course, this is just one embodiment of the server 104 and the number and types of user devices 102 is limited only by the imagination.

Further, the system may have several servers 104 which are specifically built for specific functions. In other embodiments, a single server 104 which may have one or more processors physically configured to execute the described functions, may be used to execute the various functions. Moreover, the functions may operate in a cloud computing environment where the functions are split among one or more server which adapt to execute the parts of the functions assigned to servers 104 in the cloud.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The user devices, terminals, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, terminals, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, terminals, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, terminals, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving data transfer. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. (canceled)

2. A method for enabling an Internet of Things (IoT) device to initialize payments using a virtual wallet service comprising:
receiving, at a computing device executing a virtual wallet application, a request payment authentication from an IoT device server, the IoT device server corresponding to the IoT device, the request payment authentication including an original Call ID, a user ID, a merchant external ClientID, and a SKU, the user ID corresponding to one or more of the computing device and the virtual wallet, and the SKU corresponding to product data at a merchant server;
initiating the virtual wallet application at the computing device;
receiving a payment method selection at the virtual wallet application; and
receiving, at the virtual wallet application, a new Call ID from a virtual wallet server;
wherein the new Call ID includes payment data corresponding to the payment method selection, and the new Call ID allows only the merchant server to decrypt the payment data.

3. The method of claim 2, wherein initiating the virtual wallet application at the computing device further comprises, in response to an activate for payment signal, communicating an activation notification from the IoT device to the virtual wallet application and order information for the product data for the merchant to the IoT server.

4. The method of claim 3, further comprising, in response to the activation notification and the order information, communicating the new Call ID and a Merchant External Client ID to a virtual wallet open platform.

5. The method of claim 4, further comprising, in response to the new Call ID and the Merchant External Client ID, returning the new Call ID to the IoT server from the virtual wallet open platform.

6. The method of claim 5, further comprising communicating an order request to a merchant server including the new Call ID.

7. The method of claim 6, further comprising, in response to the order request, communicating a GetPayment API from the merchant server to the virtual wallet open platform using the new Call ID;

8. The method of claim 7, further comprising communicating an encrypted payload to the merchant server using a Merchant API key, the encrypted payload including consumer payment and order data.

9. The method of claim 8, wherein initiating the virtual wallet application at the computing device includes initiating the virtual wallet application at the computing device in response to the request payment authentication, and initiating the virtual wallet application at the computing device includes initiating the virtual wallet application at the computing device using an API key.

10. The method of claim 9, further comprising communicating an order confirmation notification to the virtual wallet application.

11. A system to enable an Internet of Things (IoT) device to initialize payments using a virtual wallet service, the system comprising:
a processor and a memory in communication with the processor, the memory storing instructions, that when executed by the processor, cause the processor to:
receive, at a computing device executing a virtual wallet application, a request payment authentication from an IoT device server, the IoT device server corresponding to the IoT device, the request payment authentication including an original Call ID, a user ID, a merchant external ClientID, and a SKU, the user ID corresponding to one or more of the computing device and the virtual wallet, and the SKU corresponding to product data at a merchant server;
initiate the virtual wallet application at the computing device;
receive a payment method selection at the virtual wallet application; and
receive, at the virtual wallet application, a new Call ID from a virtual wallet server;
wherein the new Call ID includes payment data corresponding to the payment method selection, and the new Call ID allows only the merchant server to decrypt the payment data.

12. The system of claim 11, wherein instructions to initiate the virtual wallet application at the computing device further comprises, in response to an activate for payment signal, instructions to communicate an activation notification from the IoT device to the virtual wallet application and order information for the product data for the merchant to the IoT server.

13. The system of claim 12, further comprising, in response to the activation notification and the order information, instructions to communicate the new Call ID and a Merchant External Client ID to a virtual wallet open platform.

14. The system of claim 13, further comprising, in response to the new Call ID and the Merchant External Client ID, instructions to return the new Call ID to the IoT server from the virtual wallet open platform.

15. The system of claim 14, further comprising instructions to communicate an order request to a merchant server including the new Call ID.

16. The system of claim 15, further comprising, in response to the order request, instructions to communicate a GetPayment API from the merchant server to the virtual wallet open platform using the new Call ID.

17. The system of claim 16, further comprising instructions to communicate an encrypted payload to the merchant server using a Merchant API key, the encrypted payload including consumer payment and order data.

18. The system of claim 17, wherein instructions to initiate the virtual wallet application at the computing device includes instructions to initiate the virtual wallet application at the computing device in response to the request payment authentication, and instructions to initiate the virtual wallet application at the computing device includes instructions to initiate the virtual wallet application at the computing device using an API key.

19. The system of claim 18, further comprising instructions to communicate an order confirmation notification to the virtual wallet application.
